(19) United States
(12) Patent Application Publication
(10) Pub. No.: US 2013/0106928 A1
(43) Pub. Date: May 2, 2013

(54) NAIL ART DEVICE

(71) Applicant: Sang Young Lee, Seoul (KR)

(72) Inventor: Sang Young Lee, Seoul (KR)

(21) Appl. No.: 13/699,841

(22) PCT Filed: May 25, 2011
(86) PCT No.: PCT/KR2011/003839

§ 371 Date: Jan. 18, 2013

(30) Foreign Application Priority Data
May 26, 2010 (KR) 10-2010-0049054
Oct. 20, 2010 (KR) 10-2010-0102390

(51) Int. Cl. B41F 17/34

(52) U.S. Cl. CPC B41F 17/34
USPC 347/2

(57) ABSTRACT

A nail art device is provided. The device includes a finger holder for fixing a finger; and a printer unit for printing an image on the nail of the finger fixed by the finger holder, wherein the printer unit includes a printer head provided on a printer head frame, a first moving unit for moving the printer head left and right, and a second moving unit for moving the printer head frame forwards and backwards, the second moving unit including a driving motor, a first driving member that is driven by the driving motor, a second driving member that is spaced apart from the first driving member, and facilitates contact by coming into close contact with the first driving member when printing an image on the nail, and simultaneously guides the forward-and backward movement of the first driving member, and a second driving member elevating module.

### TECHNICAL FIELD

The present invention relates to a nail art device, and more particularly to a nail art device which can automatically print a desired image on a nail.

### BACKGROUND ART

In general, nail art is a creative art form that can be performed on a narrow area of a nail, and various techniques are used to decorate the nails and enjoy fashionable nails.

In such nail art, since an image needs to be painted on a very small area of the nail, only a few specialists who have professionally studied nail art can easily perform such paint. Further, since the nail art painting is manually performed, it is time-consuming.

That is, with the development of society, consumer interest in nail art has increased along with demand for beauty treatment, but the professional services of painting an image on the nails and managing the image as provided at a nail art shop is time-consuming and expensive.

### DISCLOSURE

### Technical Problem

Therefore, the present invention has been made in view of the above problems, and it is an object of the present invention to provide a nail art device which can automatically print a desired image on a nail.

It is another object of the present invention to provide a nail art device which can precisely control movement of a print head to produce a high quality image on the nail.

### Technical Solution

In accordance with an aspect of the present invention, the above and other objects can be accomplished by the provision of a nail art device including a finger holder for holding a finger and a printer unit for printing an image on a nail of the finger held by the finger holder,

wherein the printer unit includes a printer head installed at a printer head frame, a first moving unit for laterally moving the printer head, and a second moving unit for moving the printer head frame forward and backward,

wherein the second moving unit includes

a drive motor, a first drive member driven by the drive motor, a second drive member installed spaced apart from the first drive member and allowed to closely contact the first drive member to guide forward and backward movement of the first drive member when an image is printed on the nail, a second drive member elevating module for elevating the second drive member to allow the second drive member to closely contact the first drive member when the image is printed on the nail and spacing the second drive member apart from the first drive member when the image is not printed on the nail.

The first drive member includes pinion gears, and

the second drive member includes a rack gear engaged with the first drive member.

The first drive member includes a cylinder-shaped friction wheel, and

the second drive member includes a flat plate-shaped friction rack allowing the first drive member to perform rolling movement in contact therewith.

At least one of the first drive member and second drive member is formed of a flexible material.

The first drive member is axially coupled to a connection member connected to the printer head frame, and

the second drive member is disposed to extend in a front-rear direction.

The second drive member elevating module includes a drive motor, a second drive member frame having an accommodation groove for accommodating the second drive member therein, an elevation plate disposed at one side of the second drive member frame to be pin-connected with the second drive member, and an elevation bar coupled with the elevation plate to elevate the elevation plate through rotation of the drive motor.

The second drive member elevating module further includes a crank arm mounted on a crank shaft rotated by a rotation of the drive motor, and a crank pin installed at the crank arm to be eccentric with respect to the crank shaft,

wherein the elevation bar is provided with a first guide hole into which the crank pin is inserted and guided such that the elevation bar is elevated when the drive motor rotates.

A second guide hole is provided at one side of the second drive member frame to be penetrated by a pin member pin-connecting the second drive member and the elevation plate,

wherein the second guide hole vertically extends to guide elevation of the pin member according to elevation of the elevation plate.

An elastic member for elastically supporting the second drive member is installed at the accommodation groove of the second drive member frame.

The first moving unit includes a drive motor, and a timing belt installed on the printer head frame to be moved by rotation of the drive motor and connected to the printer head to laterally move the printer head when the drive motor rotates.

In accordance with another aspect of the present invention, there is provided a nail art device including a finger holder for holding a finger and a printer unit 20 for printing an image on a nail of the finger held by the finger holder,

wherein the printer unit includes a printer head installed at a printer head frame, a first moving unit for laterally moving the printer head, and a second moving unit for moving the printer head frame forward and backward,

wherein the second moving unit includes

a drive motor, a movable first drive member in a cylinder shape driven by the drive motor, a connection member adapted to fix the first drive member thereto and be connected to the printer head frame, a fixed second drive member formed in a flat plate shape to guide forward and backward movement of the first drive member,

wherein tat least one of the first drive member and second drive member is formed of a flexible material.

### Advantageous Effects

The nail art device of the present invention provides convenience and shortens time of printing by automatically printing an image desired by a user through a printer unit.

In addition, the nail art device of the present invention prevents slippage and thus can print a high quality image on a nail since a first drive member and second drive member, at least one of which is formed of a flexible material, closely contact each other to move a printer head frame forward and backward.

Further, since the nail art device of the present invention allows close contact between the first drive member and second drive member of the second moving unit only when an image is printed on a nail, forward and backward movement of the printer head can be prevented during cleaning or alignment of the printer head.

### DESCRIPTION OF DRAWINGS

FIG. 1 is a view schematically illustrating a nail art device according to the present invention;

FIG. 2 is a perspective view illustrating a printer unit of the nail art device according to the present invention;

FIG. 3 is a plan view illustrating a first moving unit of the nail art device according to the present invention;

FIG. 4 is a perspective view illustrating a second moving unit of the nail art device according to the present invention;

FIG. 5 is an exploded perspective view illustrating the second moving unit of FIG. 4;

FIG. 6 is a perspective view illustrating another embodiment of a second moving unit of the nail art device according to the present invention; and

FIG. 7 is a view illustrating operation of the second moving unit of the nail art device according to the present invention.

<Description of reference numerals of main constituents>

| | | | |
|---|---|---|---|
| 2: | input unit | 3: | printer assembly |
| 10: | finger holder | 20: | printer unit |
| 30: | printer head | 31: | printer head tray |
| 33: | printer head frame | 40: | first moving unit |
| 41: | first drive motor | 43: | timing pulley |
| 45: | timing belt | 50: | second moving unit |
| 51: | second drive motor | 52: | connection member |
| 53: | first drive member | 53a | and 53b: first and second pinion gears |
| 153: | cylindrical friction wheel | 54: | second drive member |
| 55: | rack gear | 155: | flat plate-shaped friction rack |
| 60: | second drive member elevating module | 61: | third drive motor |
| 62: | second drive member frame | 62a: | accommodation groove |
| 62b: | second guide hole | 62c: | elastic member |
| 63: | elevation plate | 64: | elevation bar |
| 64a: | first guide hole | 65: | crank pin |
| 66: | crank arm | 67: | crank shaft |

### BEST MODE

Hereinafter, a nail art device according to the present invention will be described in detail with reference to the accompanying drawings.

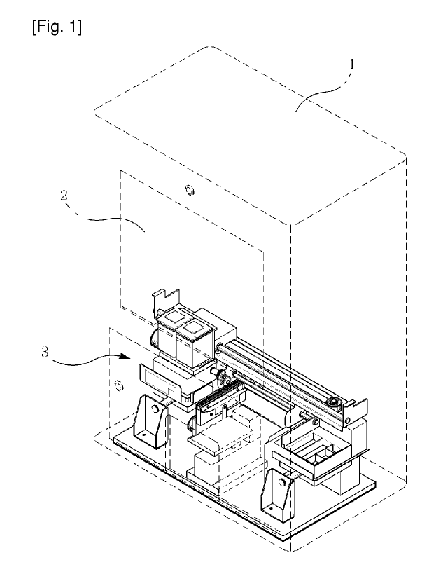

As shown in FIG. 1, the nail art device of the present invention includes an input unit 2 for selection of an image to be printed on a nail, a printer assembly 3 for printing the selected image on the nail, and a controller (not shown) for controlling operation of the printer assembly 3.

As described above, the input unit 2 allows selection of an image to print on a nail and changing the size and position of the selected image. The input unit 2 is provided with a touchscreen installed at one side of a case 1 forming an outer appearance of the nail art device to allow a user to easily select an image and change the size and position of the selected image.

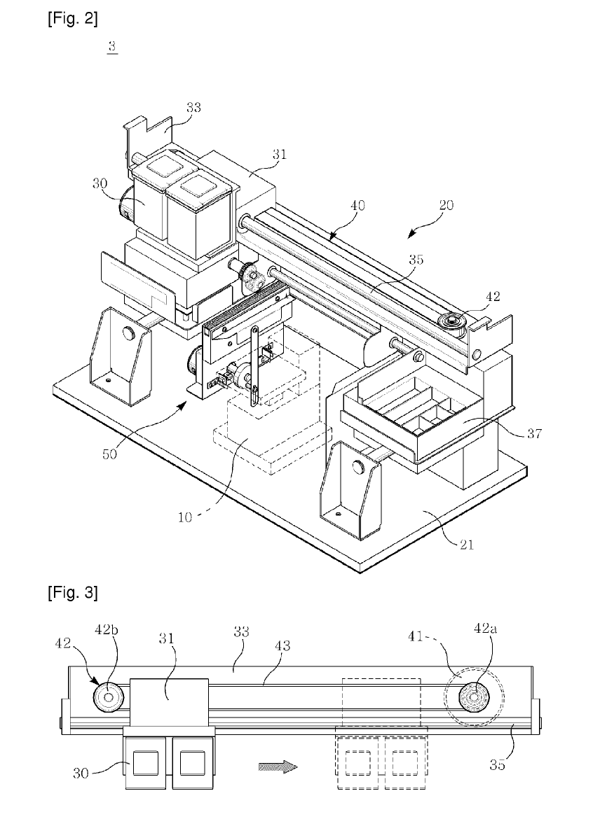

As shown in FIG. 2, the printer assembly 3 includes a finger holder 10 for holding a finger of the user, a printer unit 20 for printing the image selected by the input unit 2 on the nail.

The finger holder 10 serves to seat therein a finger of the user and hold the nail on which an image is to be printed.

The printer unit 20 includes a printer head 30 for printing an image on the nail held by the finger holder 10, a first moving unit 40 for laterally moving the printer head 30 in the process of printing the image on the nail, and a second moving unit 50 for moving the printer head 30 forward and backward in the process of printing the image on the nail.

The printer head 30 is provided with a common inkjet cartridge to print an image of various colors on the nail. The printer head 30 is mounted on a printer head tray 31, and the printer head tray 31 with the printer head 30 mounted thereon is installed at a printer head frame 33 installed at the front area of a base plate 21 in the widthwise direction of the base plate 21. Reference numeral 37 indicates a cleaner to clean the printer head 30.

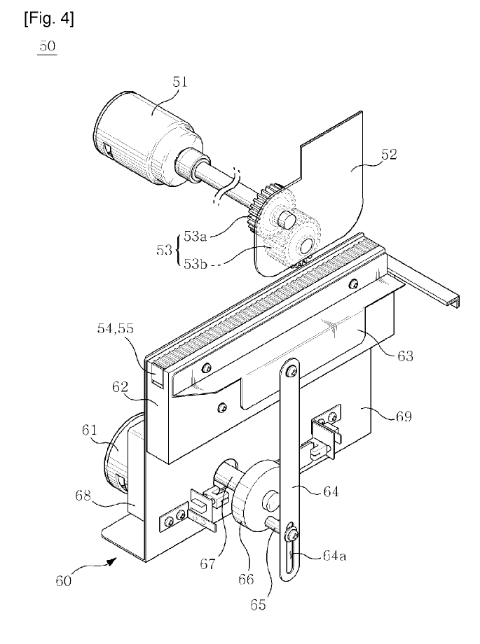

The first moving unit 40 is installed at the printer head frame 33 to laterally move the printer head 30 as described above. As shown in FIGS. 2 and 3, the first moving unit 40 includes a first drive motor 41, a timing pulley 42 including a drive pulley 42a rotated by the first drive motor 41 and a driven pulley 42b spaced apart from the drive pulley 42a, and a timing belt 43 mounted on the timing pulley 42 and is provided with the printer head tray 31.

A gear box (not shown) configured with a plurality of gears may be further installed between the first drive motor 41 and the drive pulley 42a of the timing pulley 42. Installed at the printer head frame 33 is a guide rod 35 to guide lateral movement of the printer head tray 31.

Since the timing belt 43, which is installed in the longitudinal direction of the printer head frame 33, i.e., the lateral direction of the nail art device, and to which the print head tray 31 is installed C̅h̅r̅o̅m̅e̅.̅I̅n̅k̅, the print head 30 can move in the lateral direction along with movement of the timing belt 43 when the first drive motor 41 rotates.

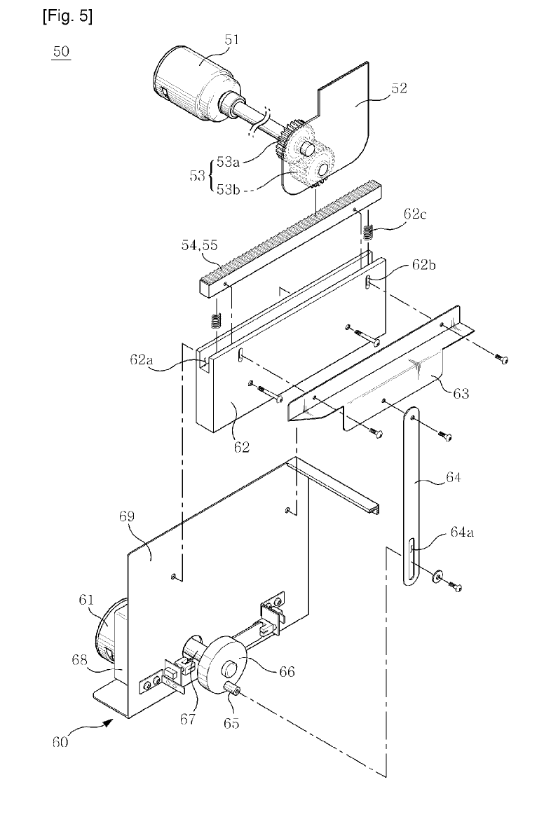

The second moving unit 50 moves the print head frame 33 forward and backward. A first embodiment of the second moving unit is described below with reference to FIGS. 4 and 5.

The second moving unit 50 includes a second drive motor 51, a first drive member 53 driven by the second drive motor 51, a connection member 52 axially coupled with the first drive member 53 and connected to the printer head frame 33, a second drive member 54 installed spaced apart from the first drive member 53 and allowed to closely contact the first drive member 53 to guide forward and backward movement of the first drive member 53 when an image is printed on a nail, a second drive member elevating module 60 for elevating the second drive member 54 such that the second drive member 54 closely contacts the first drive member 53.

Specifically, the second drive motor 51 is a common electric motor.

The first drive member 53 includes a first pinion gear 53a mounted on the shaft of the second drive motor 51, and a second pinion gear 53b engaged with the first pinion gear 53a. The illustrated embodiment of the present invention described above has two pinions, but one or at least three pinions may be mounted.

The pinions 53a and 53b are formed of a flexible material such as rubber or silicone. At least the second pinion 53b to closely contact the second drive member 54 is preferably formed of a flexible material.

As described above, the connection member 52 may be a connection bracket connected to the printer head frame 33. The first pinion gear 53a and second pinion gear 53b, i.e., the first drive member 53 is axially coupled with the connection bracket.

The second drive member 54 includes a rack gear 55 disposed to extend in the front-rear direction of the nail art device of the present invention. The rack gear 55 is arranged such that it can be elevated by the second drive member elevating module 60, as described above. The rack gear 55 is elevated to be engaged with the first drive member 53, i.e., the second pinion gear 53b, only when an image is printed on a nail. In addition, the rack gear 55 is formed of a flexible material as the pinion gears.

At least one of the first drive member 53 and second drive member 54 can be formed of a flexible material as described above. If at least one of the first and second drive members 53 and 54 is formed of a flexible material, slippage does not occurs during forward and backward movement of the printer head frame 33. If slippage does not occur during forward and backward movement of the printer head frame 33, overlapping of images can be prevented during the process of printing images on a small nail and thus high quality images can be printed on the nail.

Since the nail art device of the present invention prints an image on a small nail, high precision is required. As described above, the second drive member elevating module 60 elevates the second drive member 54. When the nail art device prints an image on the nail, the second drive member elevating module 60 elevates the second drive member 54 such that the second drive member 54 closely contacts the first drive member 53. When the nail art device does not print an image on the nail, the second drive member elevating module 60 lowers the second drive member 54 to space the second drive member 54 apart from the first drive member 53.

The second drive member 54 is allowed to closely contact the first drive member 53 only when an image is printed on the nail, so that in the process of lateral alignment of the printer head 30 for printing of the image on the nail, the first drive member 53 does not closely contact the second drive member 54, preventing forward and backward movement of the printer head 30 and thus enabling smooth alignment of the printer head 30.

In addition, the second drive member 54 is allowed to closely contact the first drive member 53 only when an image is printed on the nail, so that when the printer head 30 is laterally moved to the cleaner installed at one side of the printer head frame 33 and cleaned, forward and backward movement of the printer head 30, which prevents the printer head 30 from being easily housed in the cleaner 37, may not be caused by close contact between the first drive member 53 and the second drive member 54.

The second drive member elevating module 60 includes a third drive motor 61, a second drive member frame 62 having an accommodation groove 62a in which the second drive member 54 is accommodated, an elevation plate 63 disposed at one side of the second drive member frame 62 to be pin-connected with the second drive member 54 by a pin member, an elevation bar 64 coupled with the elevation plate 63 to elevate the elevation plate 63 through rotation of the third drive motor 61.

Specifically, the third drive motor 61 is a common electric motor.

As shown in FIG. 4, the second drive member frame 62 is installed at one side of a side plate 69 coupled to the top surface of a base plate 21 in a front-rear direction. With reference to FIG. 5, the accommodation groove 62a for accommodation of the second drive member 54, i.e., the rack gear 55 as described above is formed at the top surface of the second drive member frame 62. Installed at the accommodation groove 62a is an elastic member 62c to elastically support the second drive member 54.

Also, a guide hole 62b is formed at one side of the second drive member frame 62 to vertically extend for pin-connection of the elevation plate 63 with the second drive member 54. That is, a pin member connecting the elevation plate 63 with the second drive member 54 is guided by the guide hole 62b to operatively connect the elevation of the elevation plate 63 to the second drive member 54.

The elevation plate 63 is moved in connection with the elevation of the elevation bar 64, and this movement of the elevation plate 63 is transferred to the second drive member 54.

The elevation bar 64 is arranged to be elevated by rotation of the third drive motor 61, a guide hole 64a is formed in the elevation bar 64 to vertically extend.

Also, the second drive member elevating module 60 further includes a gear box 68 configured with a plurality of gears connected with the third drive motor 61 to reduce rotational force of the third drive motor 61, a crank arm 66 mounted on a crank shaft 67 axially connected with one of the gears of the gear box 68, and a crank pin 65 installed at the crank arm 66 to be eccentric with respect to the crank shaft 67. The crank pin 65 is inserted into the guide hole 64a formed in the elevation bar 64 to vertically move the elevation bar 64 when the third drive motor 61 rotates.

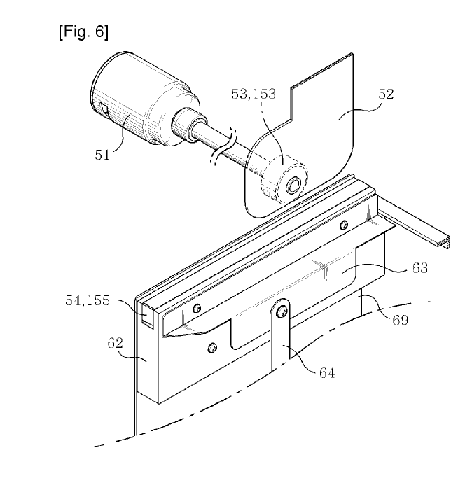

Next, a second embodiment of the second moving unit of the nail art device of the present invention is described below with reference to FIG. 6. Components of the second moving unit identical to those of the first embodiment are given the same reference numerals and a detailed description thereof is omitted.

The second moving unit 50 includes a second drive motor 51, a first drive member 53 driven by the second drive motor 51, a connection member 52 axially coupled with the first drive member 53 and connected to the printer head frame 33, a second drive member 54 installed spaced apart from the first drive member 53 and allowed to closely contact the first drive member 53 to guide forward and backward movement of the first drive member 53 when an image is printed on a nail, a second drive member elevating module 60 to elevate the second drive member 54 such that the second drive member 54 closely contacts the first drive member 53.

Specifically, the first drive member 53 is a cylindrical friction wheel 153 axially connected with the second drive motor 51, and the second drive member 54 is a flat plate-shaped friction rack 155 without gear teeth which is arranged in the front-rear direction of the nail art device of the present invention to allow the cylindrical friction wheel 153 to roll thereon when elevated by the second drive member elevating module 60.

The first drive member 53 provided with the cylinder-shaped friction wheel 153 and the second drive member 54 provided with the flat plate-shaped friction rack 155 are formed of a flexible material such as rubber or silicone.

Hereinafter, operation of the nail art device of the present invention will be described with reference to the paintings.

With reference to FIG. 1, in order to print an image on a nail using the nail art device of the present invention, an image desired by a user is selected through the input unit 2.

After a finger is held by the finger holder 10, the selected image is applied to the nail image displayed on the input unit 2 through a camera to change the size and position of the image.

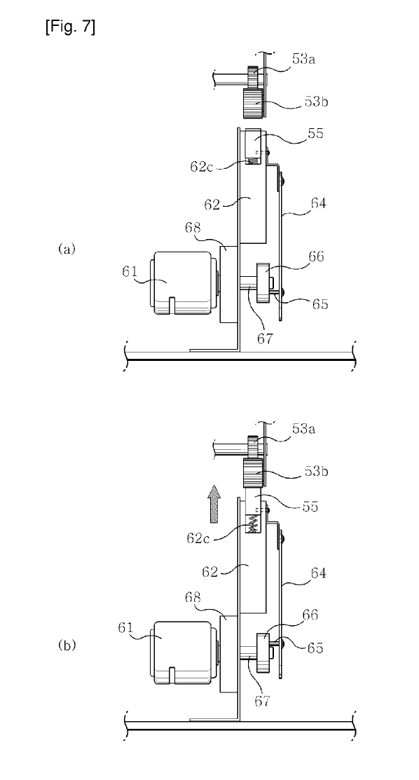

Thereafter, as shown in FIG. 7, the second drive member elevating module 60 is operated to allow the second drive member 55 to closely contact the first drive member 53. Specifically, the third drive motor 61 is operated to transfer the rotational force of the third drive motor 61 to the elevation bar 64 to elevate the elevation bar 64 and elevate the second drive member 55 with the elevation plate 63 according to elevation of the elevation bar 64 such that the second drive member 55 closely contacts the first drive member 53.

When the second drive member 55 closely contacts the first drive member 53, the selected image is printed on the nail held by the finger holder 10. Here, the operation of the printer unit 20 is performed by laterally moving the printer head 30 on the printer head frame 33 using the first moving unit 40 and moving the printer head frame 33 forward and backward using the second moving unit 50.

Since the first drive member 53 and second drive member 55 are formed of a flexible material such as rubber or silicone, the first drive member 53 can move forward and backward in close contact with the second drive member 55, without slipping.

1. A nail art device including a finger holder 10 for holding a finger and a printer unit 20 for printing an image on a nail of the finger held by the finger holder 10,
wherein the printer unit 20 comprises a printer head 30 installed at a printer head frame 33, a first moving unit 40 for laterally moving the printer head 30, and a second moving unit 50 for moving the printer head frame 33 forward and backward,
wherein the second moving unit 50 comprises:
a drive motor 51, a first drive member 53 driven by the drive motor 51, a second drive member 54 installed spaced apart from the first drive member 53 and allowed to closely contact the first drive member 53 to guide forward and backward movement of the first drive member 53 when an image is printed on the nail, a second drive member elevating module 60 for elevating the second drive member 54 to allow the second drive member 54 to closely contact the first drive member 53 when the image is printed on the nail and spacing the second drive member 54 apart from the first drive member 53 when the image is not printed on the nail.

2. The nail art device according to claim 1, wherein the first drive member 53 comprises pinion gears 53a and 53b, and the second drive member 54 comprises a rack gear 55 engaged with the first drive member 53.

3. The nail art device according to claim 1, wherein the first drive member 53 is a cylindrical friction wheel 153, and the second drive member 54 is a flat plate-shaped friction rack 155 allowing the first drive member 53 to perform rolling movement in contact therewith.

4. The nail art device according to claim 2, wherein at least one of the first drive member 53 and second drive member 54 is formed of a flexible material.

5. The nail art device according to claim 1, wherein the first drive member 53 is axially coupled to a connection member 52 connected to the printer head frame 33, and the second drive member 54 is disposed to extend in a front-rear direction.

6. The nail art device according to claim 1, wherein the second drive member elevating module 60 comprises:
a drive motor 61;
a second drive member frame 62 having an accommodation groove 62a for accommodating the second drive member 54 therein;
an elevation plate 63 disposed at one side of the second drive member frame 62 to be pin-connected with the second drive member 54; and
an elevation bar 64 coupled with the elevation plate 63 to elevate the elevation plate 63 through rotation of the drive motor 61.

7. The nail art device according to claim 6, wherein the second drive member elevating module 60 further comprises a crank arm 66 mounted on a crank shaft 67 rotated by a rotation of the drive motor 61, and a crank pin 65 installed at the crank arm 66 to be eccentric with respect to the crank shaft 67,
wherein the elevation bar 64 is provided with a first guide hole into which the crank pin 65 is inserted and guided such that the elevation bar 64 is elevated when the drive motor 61 rotates.

8. The nail art device according to claim 6, wherein a second guide hole 62b is provided at one side of the second drive member frame 62 to be penetrated by a pin member pin-connecting the second drive member 54 and the elevation plate 63,
wherein the second guide hole 62b vertically extends to guide elevation of the pin member according to elevation of the elevation plate 63.

9. The nail art device according to claim 6, wherein an elastic member 62c for elastically supporting the second drive member 54 is installed at the accommodation groove 62a of the second drive member frame 62.

10. The nail art device according to claim 1, wherein the first moving unit 40 comprises:
a drive motor 41; and
a timing belt 43 installed on the printer head frame 33 to be moved by rotation of the drive motor 41 and connected to the printer head 30 to laterally move the printer head 30 when the drive motor 41 rotates.

11. A nail art device including a finger holder 10 for holding a finger and a printer unit 20 for printing an image on a nail of the finger held by the finger holder 10,
wherein the printer unit 20 comprises a printer head 30 installed at a printer head frame 33, a first moving unit 40 for laterally moving the printer head 30, and a second moving unit 50 for moving the printer head frame 33 forward and backward,
wherein the second moving unit 50 comprises:
a drive motor 51, a movable first drive member 53 in a cylinder shape driven by the drive motor 51, a connection member 52 adapted to fix the first drive member 53 thereto and be connected to the printer head frame 33, a fixed second drive member 54 formed in a flat plate shape to guide forward and backward movement of the first drive member,
wherein at least one of the first drive member 53 and second drive member 54 is formed of a flexible material.

12. The nail art device according to claim 11, wherein the second moving unit 50 further comprises a second drive member elevating module 60 for elevating the second drive member 54 to allow the second drive member 54 to closely contact the first drive member 53 when the image is printed on the nail and spacing the second drive member 54 apart from the first drive member 53 when the image is not printed on the nail,
wherein the second drive member elevating module 60 comprises:
a drive motor 61;
a second drive member frame 62 having an accommodation groove 62a for accommodating the second drive member 54 therein;
an elevation plate 63 disposed at one side of the second drive member frame 62 to be pin-connected with the second drive member 54; and
an elevation bar 64 coupled with the elevation plate 63 to elevate the elevation plate 63 through rotation of the drive motor 61.

13. The nail art device according to claim 11, wherein the first moving unit 40 comprises:
a drive motor 41; and
a timing belt 43 installed on the printer head frame 33 to be moved by rotation of the drive motor 41 and connected to the printer head 30 to laterally move the printer head 30 when the drive motor 41 rotates.

14. The nail art device according to claim 3, wherein at least one of the first drive member 53 and second drive member 54 is formed of a flexible material.
